(19) United States
(12) Patent Application Publication
(10) Pub. No.: US 2012/0284743 A1
(43) Pub. Date: Nov. 8, 2012

(54) INTERACTIVE MULTI-STREAM ADVERTISEMENT

(76) Inventors: MARK UNAK, Wilmette, IL (US); Thomas Morgan, San Mateo, CA (US); Ralf Jacob, Newbury Park, CA (US); Brian Duersch, Mountain View, CA (US)

(21) Appl. No.: 13/109,551

(22) Filed: May 17, 2011

Related U.S. Application Data
(60) Provisional application No. 61/483,304, filed on May 6, 2011.
(60) Provisional application No. 61/483,475, filed on May 6, 2011.

(51) Int. Cl. H04N 7/10

(52) U.S. Cl. 725/32

(57) ABSTRACT

An advertisement is generated including a plurality of associated media streams. The advertisement complex is delivered over a computing network to a network connected video consumption device.

### CROSS-REFERENCE TO RELATED APPLICATIONS

This application claims the benefit of U.S. provisional patent application Ser. No. 61/483,304, filed 6 May 2011, entitled “Television System and Method,” and also claims the benefit of U.S. provisional patent application Ser. No. 61/483,475, filed 6 May 2011, entitled “Television System and Method,” the entirety of both of which are incorporated herein by reference.

### TECHNICAL FIELD

The present disclosure generally relates to advertisements, and more particularly relates to interactive, multi-stream advertisements.

### BACKGROUND

Advertising is often used in connection with various media sources, such as television, print media, internet media, and the like. Due to time or space constraints, advertisements generally include a brief messaged directed at gaining a consumers attention. However, due to the time or space constraints there is often no ability include any detailed information about the subject matter of the advertisement. As such, advertisements typically rely on preexisting consumer knowledge or creating enough consumer interest to motivate additional research by the consumer.

### SUMMARY

According to an implementation, a method may include generating, via a computing device, an advertisement complex including a plurality of associated media streams. The advertisement complex may be delivered by the computing device over a computing network to a network connected video consumption device.

One or more of the following features may be included. The advertisement complex may include a user selectable graphical representation associated with each of the plurality of associated media streams. Delivering the advertisement complex may include delivering a first media stream of the plurality of associated media streams as an active media stream. A second media stream of the plurality of associated media streams may be delivered as the active media stream in response to, at least in part, receiving a user selection associated with the second media stream. Delivering the second media stream as the active media stream may include displaying the second media stream in an active pane of the advertisement complex.

Delivering the advertisement complex may include delivering the advertisement complex as an advertisement within a television program.

The method may also include determining an advertisement consumption analytic based upon, at least in part, an identity of viewed media streams, a number of viewed video streams, and a video stream play-out metric. An advertisement value may be calculated based upon, at least in part, the advertisement consumption analytic. One or more viewer demographics may be determined based upon, at least in part, a user profile associated with the video consumption device.

According to another implementation, a computer program product includes a computer readable medium having a plurality of instructions stored on it. When the instructions are executed by a processor, the instructions may cause the processor to perform operations including generating an advertisement complex including a plurality of associated media streams. The instructions may also cause the processor to deliver the advertisement complex over a computing network to a network connected video consumption device.

One or more of the following features may be included. The advertisement complex may include a user selectable graphical representation associated with each of the plurality of associated media streams. The instructions for delivering the advertisement complex may include instructions for delivering a first media stream of the plurality of associated media streams as an active media stream. Instructions may be included for delivering a second media stream of the plurality of associated media streams as the active media stream in response to, at least in part, receiving a user selection associated with the second media stream. The instructions for delivering the second media stream as the active media stream may include instructions for displaying the second media stream in an active pane of the advertisement complex.

The instructions for delivering the advertisement complex may include instructions for delivering the advertisement complex as an advertisement within a television program.

The computer program product may include instructions for determining an advertisement consumption analytic based upon, at least in part, an identity of viewed media streams, a number of viewed video streams, and a video stream play-out metric. Instructions may also be included for calculating an advertisement value based upon, the advertisement consumption analytic. Instructions may also be included for determining one or more viewer demographics based upon, at least in part, a user profile associated with the video consumption device.

According to a further implementation, a system may include a processor, and a memory architecture coupled with the processor. A first software module may be executable by the processor and the memory architecture. The first software module may be configured to generate an advertisement complex including a plurality of associated media streams. A second software module may also be executable by the processor and the memory architecture. The second software module may be configured to deliver the advertisement complex over a computing network to a network connected video consumption device. The advertisement complex may include a user selectable graphical representation associated with each of the plurality of associated media streams. The first software module, configured to deliver the advertisement complex, may be further configured to deliver a first media stream of the plurality of associated media streams as an active media stream. A third software module may be configured to deliver a second media stream of the plurality of associated media streams as the active media stream in response to, at least in part, receiving a user selection associated with the second media stream. The third software module, configured to deliver the second media stream as the active media stream, may be configured to display the second media stream in an active pane of the advertisement complex.

The second software module, configured to deliver the advertisement complex, may be configured to deliver the advertisement complex as an advertisement within a television program. A fourth software module may be configured to determine an advertisement consumption analytic based upon, at least in part, an identity of viewed media streams, a number of viewed video streams, and a video stream play-out metric. A fifth software module may be configured to calculate an advertisement value based upon, at least in part, the advertisement consumption analytic. A sixth software module may be configured to determine one or more viewer demographics based upon, at least in part, a user profile associated with the video consumption device

The details of one or more implementations are set forth in the accompanying drawings and the description below. Other features will become apparent from the description, the drawings, and the claims.

### BRIEF DESCRIPTION OF THE DRAWINGS

FIG. 1 diagrammatically depicts an advertisement process coupled to a distributed computing network.

FIG. 2 is a flowchart of a process executed by the advertisement process of FIG. 1.

FIG. 3 diagrammatically depicts an advertisement complex generated by the advertisement process of FIG. 1.

FIG. 4 diagrammatically depicts an advertisement complex generated by the advertisement process of FIG. 1.

### DETAILED DESCRIPTION OF ILLUSTRATIVE EMBODIMENTS

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer readable medium may be a computer readable signal medium or a computer readable storage medium. A computer-usable, or computer-readable, storage medium (including a storage device associated with a computing device or client electronic device) may be, for example, but not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that can contain, or store a program for use by or in connection with the instruction execution system, apparatus, or device.

A computer readable signal medium may include a propagated data signal with computer readable program coded embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

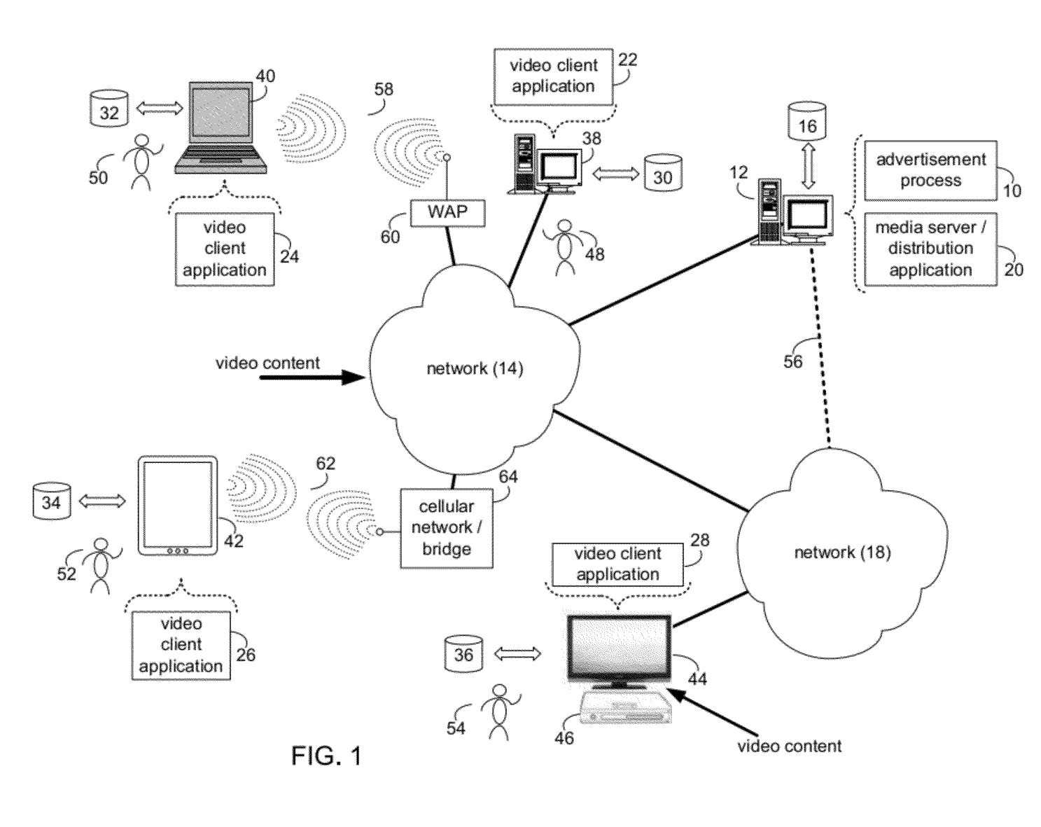

Referring to FIG. 1, there is shown advertisement process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft® Windows® Server; Novell® NetWare® or Red Hat® Linux®, for example. (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both.) Additionally/alternatively, the arrival time process may reside on and be executed, in whole or in part, by a client electronic device, such as a personal computer, notebook computer, personal digital assistant, or the like.

As will be discussed below in greater detail, advertisement process 10 may generate an advertisement complex including a plurality of associated media streams. Advertisement process 10 may further deliver the advertisement complex over a computing network to a network connected video consumption device.

The instruction sets and subroutines of advertisement process 10, which may include one or more software modules, and which may be stored on storage device 16 coupled to server computer 12, may be executed by one or more processors (not shown) and one or more memory modules (not shown) incorporated into server computer 12. Storage device 16 may include but is not limited to: a hard disk drive; a solid state drive, a tape drive; an optical drive; a RAID array; a random access memory (RAM); and a read-only memory (ROM).

Server computer 12 may execute a web server application, examples of which may include but are not limited to: Microsoft IIS, Novell Webserver™, or Apache® Webserver, that allows for HTTP (i.e., HyperText Transfer Protocol) access to server computer 12 via network 14 (Webserver is a trademark of Novell Corporation in the United States, other countries, or both; and Apache is a registered trademark of Apache Software Foundation in the United States, other countries, or both). Network 14 may be connected to one or more secondary networks (e.g., network 18), examples of which may include but are not limited to: a local area network; a wide area network; or an intranet, for example.

Server computer 12 may execute a media server/distribution application (e.g., media server/distribution application 20). Media server/distribution application 20 may interact with one or more video client applications (e.g., video client applications 22, 24, 26, 28) for providing or distributing media content to video client application 22, 24, 26, 28. Examples of video client applications 22, 24, 26, 28 may include, but are not limited to, e.g., Adobe Flash Player, an HTML 5 web browser, proprietary media player, etc. (Adobe and Flash Player are registered trademarks of Adobe Systems Incorporated in the United States, other countries, or both).

Advertisement process 10 may be a stand alone application, or may be an applet/application/script that may interact with and/or be executed within media server/distribution application 20. In addition/as an alternative to being a server-side process, the advertisement process may be a client-side process (not shown) that may reside on a client electronic device (described below) and may interact with a video client application (e.g., one or more of video client applications 22, 24, 26, 28). Further, the advertisement process may be a hybrid server-side/client-side process that may interact with media server/distribution application 20 and a video client application (e.g., one or more of video client applications 22, 24, 26, 28). As such, the advertisement process may reside, in whole, or in part, on server computer 12 and/or one or more client electronic devices.

The instruction sets and subroutines of media server/distribution application 20, which may be stored on storage device 16 coupled to server computer 12 may be executed by one or more processors (not shown) and one or more memory modules (not shown) incorporated into server computer 12.

The instruction sets and subroutines of video client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory modules (not shown) incorporated into client electronic devices 38, 40, 42, 44/46 (respectively). Storage devices 30, 32, 34, 36 may include but are not limited to: hard disk drives; solid state drives, tape drives; optical drives; RAID arrays; random access memories (RAM); read-only memories (ROM), compact flash (CF) storage devices, secure digital (SD) storage devices, and a memory stick storage devices. Examples of client electronic devices 38, 40, 42, 44/46 may include, but are not limited to, personal computer 38, laptop computer 40, mobile computing device 42 (such as a tablet computer, netbook, data enable cellular phone, or the like), internet capable television 44 and/or internet capable set-top box 46, for example. Using client applications 22, 24, 26, 28, users 48, 50, 52, 54 may access media server/distribution application 20 and may allow users to e.g., receive advertising media content.

Users 48, 50, 52, 54 may access scheduling application 20 directly through the device on which the video client application (e.g., video client applications 22, 24, 26, 28) is executed, namely client electronic devices 38, 40, 42, 44/46, for example. Users 48, 50, 52, 54 may access media server/distribution application 20 directly through network 14 or through secondary network 18. Further, server computer 12 (i.e., the computer that executes media server/distribution application 20) may be connected to network 14 through secondary network 18, as illustrated with phantom link line 56.

The various client electronic devices may be directly or indirectly coupled to network 14 (or network 18). For example, personal computer 38 is shown directly coupled to network 14 via a hardwired network connection. Further, internet capable television 44 and/or internet capable set-top box is shown directly coupled to network 18 via a hardwired network connection. Laptop computer 40 is shown wirelessly coupled to network 14 via wireless communication channel 58 established between laptop computer 40 and wireless access point (i.e., WAP) 60, which is shown directly coupled to network 14. WAP 60 may be, for example, an IEEE 802.11a, 802.11b, 802.11g, Wi-Fi, and/or Bluetooth device that is capable of establishing wireless communication channel 58 between laptop computer 40 and WAP 60. Mobile computing device 42 is shown wirelessly coupled to network 14 via wireless communication channel 62 established between mobile computing device 42 and cellular network/bridge 64, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44/46 may each execute an operating system, examples of which may include but are not limited to Microsoft Windows, Microsoft Windows CE®, Red Hat Linux, iOS, Android or other suitable operating system. (Windows CE is a registered trademark of Microsoft Corporation in the United States, other countries, or both; iOS is a registered trademark of Cisco Systems Inc. in the United States, other countries, or both; Android is a trademark of Google Inc. in the United States, other countries, or both.)

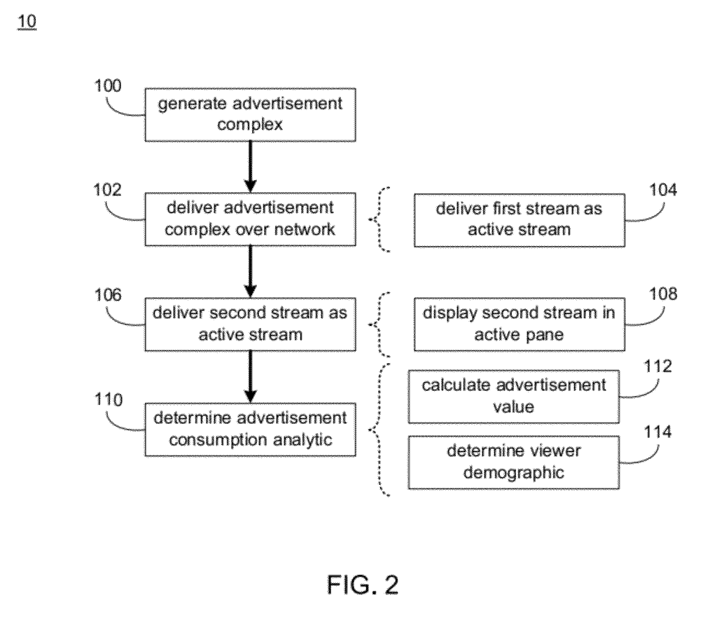

Referring also to FIG. 2, advertisement process 10 generate 100 an advertisement complex including a plurality of associated media streams. Advertisement process 10 may further deliver 102 the advertisement complex over a computing network to a network connected video consumption device. As will be described in greater detail below, generally, the advertisement complex may provide an interactive multi-message video presentation. The advertisement complex may provide advertising content over any network connected device. In a particular illustrative example, the advertisement complex may provide advertising content for television programming, such as cable television programming and/or satellite television programming (e.g., in which a video consumption device, such as television 44 and/or set top box 46 may receive television programming content from a cable or satellite provider), internet television programming (e.g., in which a video consumption device, such as person computer 38, laptop computer 40, and mobile computing device 42 may receive television programming via a computer network, such as the Internet), and the like. However, it will be appreciated that the systems and methods described herein may have applicability beyond the television advertising context.

For the purpose of the following description, video client application 22 may be discussed. However, this is for illustrative purposes only and should not be construed as a limitation of the present disclosure, as other video client applications (e.g., client application 24, 26, 28) may be equally utilized.

Consistent with the foregoing example, in which the advertisement complex may be delivered 102 as an advertisement within a television program, advertisement process 10, alone and/or in conjunction with media server/distribution application 20 may deliver 102 the advertisement complex to a video consumption device (e.g., personal computer 38, for the purpose of this illustrative example) via a computing network (e.g., network 14, which may include, but is not limited to, the Internet) to be played during an advertising break during a television program being watched by a viewer (e.g., user 46 in the illustrative example). The advertisement break (during which advertisement complex may be played) may be determined based upon, for example, a play time of the television program, an embedded indicator within the television program, or other known means for indicating an advertisement break and temporarily suspending playback of the television program while one or more advertisements are played.

Advertisement process 10 may generate 100 the advertisement complex including a plurality of associated media streams. According to an illustrative embodiment, the plurality of associated media streams may be associated with, and playable from a common interactive presentation feature. The plurality of associated media streams may include, but are not limited to, audio streams, and video streams. Each of the plurality of media streams may be activated (e.g., launched or played) based upon, at least in part, user selection.

According to various embodiments, the plurality of media streams may provide related content around a message. In an embodiment, the plurality of media streams may all pertain to a single product or message. For example, the plurality of media streams may relate to various aspects of a car being advertised. In such an example, one media stream may relate to styling aspects of the car. Another media stream may relate to performance and economy aspects of the car. Additional media streams may relate to various other aspects of the same car. In another example, the plurality of media streams may pertain to related content messages. For example, the plurality of media streams may relate to dining options, hotel options, activities, and the like of a common vacation destination. Accordingly, the advertisement complex may allow a viewer to explore related content around a common, or related, products or messages. Various additional/alternative embodiments will be readily appreciated by those having skill in the art.

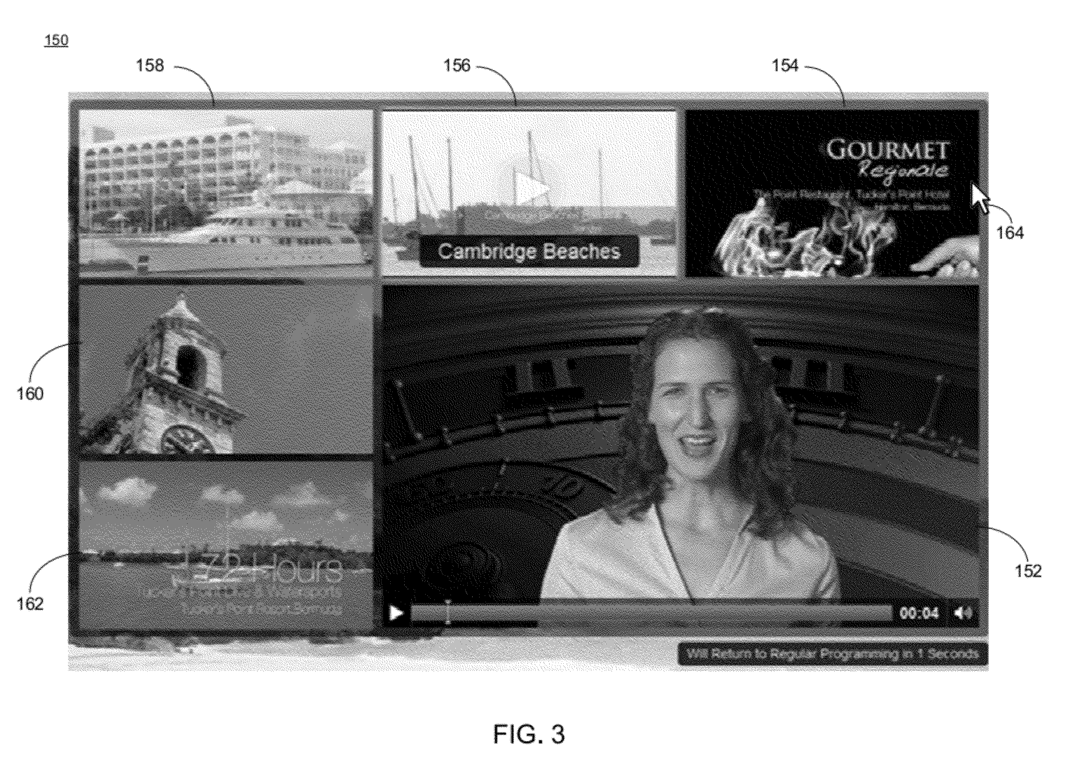

For example, and referring also to FIG. 3, advertisement complex 150 (e.g., which may be played during an advertisement break of a television program) may include a visual presentation having a plurality of discrete panes (e.g., panes 152, 154, 156, 158, 160, 162). Continuing with the illustrated example, each of panes 152, 154, 156, 158, 160, 162 may include a graphical representation associated with a respective one of the plurality of associated media streams. The respective graphical representations maybe user selectable, e.g. for activating, or launching, the media stream associated with the graphical representation. While in the illustrated embodiment the graphical representations may include still images of a portion of the respective media streams, this is intended for illustrative purposes only, as the nature of the graphical representation may vary depending upon design criteria and user need.

Delivering 102 the advertisement complex may include delivering 104 a first media stream of the plurality of associated media streams as an active media stream. For example, when advertisement complex 150 has been launched (e.g., in response to a time-wise or other indicator for an advertisement break in a television program, or the like), advertisement process 10 may deliver one or the media streams (e.g., the introduction stream) as an active media stream that may begin playback without requiring an input or action from the viewer. Consistent with the illustrated embodiment, playback of the active stream may occur in active pane 152, e.g., which may, in some embodiments, be a relatively larger pane than detail panes 154, 156, 158, 160, 162.

Consistent with the illustrated embodiment in FIG. 3, advertisement complex 150 may include an introduction stream that may be initially delivered 102 as an active stream in active pane 152. The introduction stream may serve to generate viewer interest, for example, to motivate a viewer to select one of the detail panes for activating a detail media stream relating to one aspect of the product or message, or some related content. However, the implementation of an introduction stream and one or more detail streams is provided for the purpose of illustration only, and should not be construed as a limitation of the present disclosure. Each of the plurality of media streams may relate to discrete subject matter, and advertisement complex need not include a separate introduction stream and/or a stream that may relate to all of the detail streams.

According to various embodiments, once advertisement complex 150 has been launched (e.g., in response to a time-wise or other indicator for an advertisement break in a television program, or the like), one or more of the plurality of media streams may play for a predetermined period of time. Continuing with the above-stated example in which a first media stream corresponds to an introduction media stream, once advertisement complex 150 has been launched, at least a portion of the introduction stream may play before the viewer (e.g., user 48) may return to the television program. In the even that user 48 may wish to receive additional information about the subject of the advertisement, etc., user 48 may select, via onscreen pointer 164 (e.g., which may be controlled with a pointing device, such as a mouse; not shown), a graphical representation associated with a second media stream (e.g., one or more graphical representations within pages 154, 156, 158, 160, 162).

A second media stream of the plurality of associated media streams may be delivered 106 as the active media stream in response to, at least in part, receiving a user selection associated with the second media stream. For example, assume that user 48 may select (e.g., click on) top right detail pane 154 using onscreen pointer 164. Upon advertisement process 10 receiving a user selection associated with detail pane 154, advertisement process 10 may deliver 106 the media stream associated with detail pane 154 as the active media stream. Accordingly, playback of the media stream associated with the introduction stream (in the foregoing example) displayed in active pane 152 may be suspended, and playback of the media stream associated with detail pane 154 may begin.

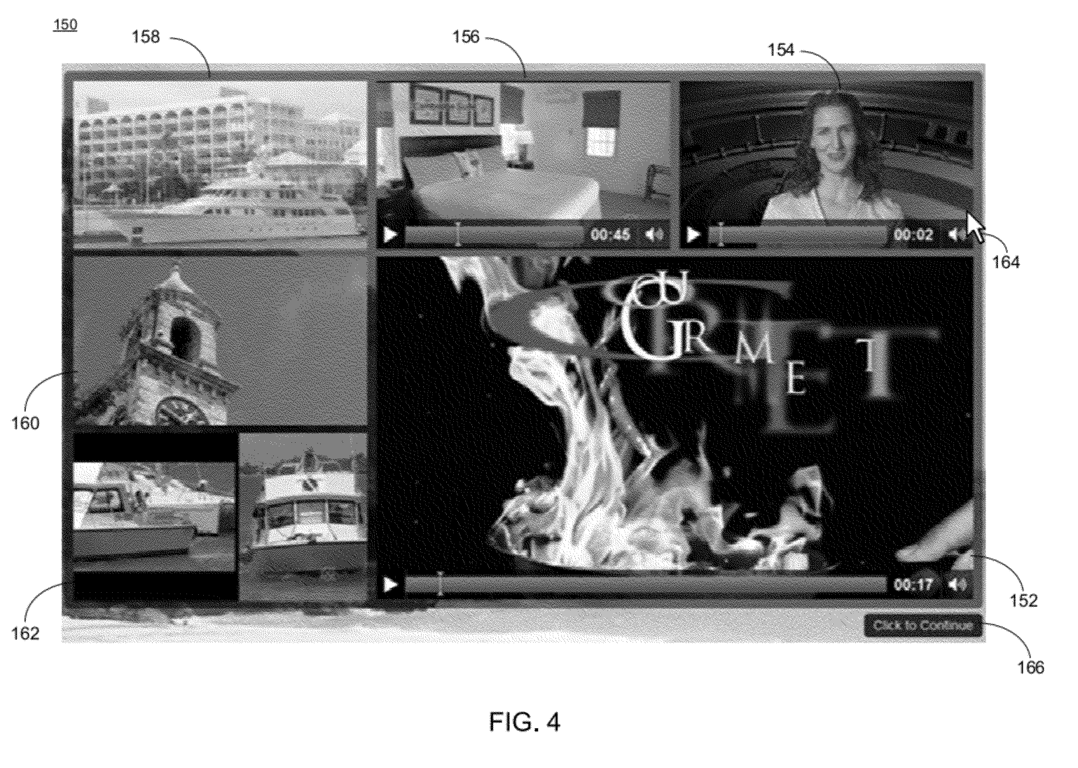

Additionally, delivering 106 the second media stream as the active media stream may include displaying 108 the second media stream in an active pane of the advertisement complex. Continuing with the above-stated example, and referring also to FIG. 4, the second media stream (previously associated with pane 154) may be played in active pane 152 (e.g., which may be a larger pane for improved viewing). Correspondingly, a graphical representation of the introduction stream (previously being played-back in active pane 152) may be displayed in pane 154.

The second media stream may continue to play, e.g., until a minimum advertising duration has been achieved, or until the viewer elects to return to the television program being watched (e.g., by selecting, via onscreen pointer 164, click to continue button 166, or other suitable control), whichever occurs later. Of course other viewing controls and requirements may be implemented depending upon design criteria and user need.

Advertisement process 10 may also determine 110 an advertisement consumption analytic for a given presentation of the advertisement complex. For example, advertisement process 10 may determine 110 an advertisement consumption analytic for every instance that the advertisement complex is played for a viewer. In general, the advertisement consumption analytic may include information relating to the quantity and components of the advertisement complex that were watched by the viewer, the degree of interaction of the viewer with the advertisement complex, and the like. As such, the determined 110 advertisement consumption analytic may be based upon, at least in part, an identity of viewed media streams, a number of viewed video streams, and a video stream play-out metric.

Continuing with the forging, advertisement process 10 may determine 110 an identity of the viewed media streams. In the previous example, advertisement complex 150 included six media streams (namely an introduction stream and five detailed media streams). Advertisement process 10 may determine 110, for example, that in addition to the introduction stream the viewer activated (e.g., clicked on) a restaurant guide stream and a hotel accommodation stream. As such, not only may advertisement process 10 determine the identity of the viewed media streams, advertisement process 10 may similarly determine 110 the number of viewed media streams.

Additionally, advertisement process 10 may determine 110 a video stream play-out metric. That is, advertisement process 10 may determine a viewed quantity of each of the viewed media streams. Continuing with the above example in which the viewer viewed the introduction stream, a restaurant guide stream, and a hotel accommodation stream, the viewed may not have watched the entirety of each stream. For example, the viewer may have watched the entirety (e.g., 100%) of the introduction stream, most (e.g., 80%) of the restaurant guide stream, and very little (e.g., 5%) of the hotel accommodation stream before returning to the television programming.

It will be appreciated that if the same advertisement complex is presented to the same viewer multiple times during a relatively short time frame (e.g., within the same television program, with the same day, etc.) the viewer may view different streams of the same advertisement complex and/or may view different quantities viewed media streams. Advertisement process 10 may determine 110 the advertisement consumption analytic each time the advertisement complex is watched. As such, advertisement process 10 may accumulate information relative to interest level and points of interest for the viewer, as well as how the viewer's interest level and point of interest may change over time.

As described above, the advertisement complex may include a multi-component (e.g., multi-stream) interactive advertisement. As such, the advertisement complex may be susceptible to various valuation (e.g., advertising fees paid by an advertiser to a media provider, such as television broadcaster) arrangements. According to an embodiment, advertisement process 10 may calculate 112 an advertisement value based upon, at least in part, the determined 110 advertisement consumption analytic. For example, a viewing instance of the advertising complex in which the viewer only watches the introduction stream before returning their television program may have a relatively low calculated 112 value. However, a viewing instance of the advertising complex in which the viewer watches the entirety of all of the media streams of the advertisement complex may have a relatively high calculated 112 value (e.g., based upon, at least in part the high level of viewer interaction and time spent consuming the advertisements). Advertisement process 10 may utilize various weighting factors and consumption analytic attributes for calculating 112 the advertisement value depending upon design criteria and user need.

According to another aspect, advertisement process 10 may deliver 102 the advertisement complex based upon, at least in part, user credentials associated with the viewer. For example, a viewer may logon to a network connected video consumption device, e.g., for the purpose of watching television. By logging onto the network connected video consumption device (and/or logging onto a video client application, such as video client application 22), a viewer (e.g., user 48). Accordingly, advertisement process 10 may determine 114 one or more viewer demographics based upon, at least in part, a user profile associated with the video consumption device. The user profile of the viewer may include information such as, age gender, marital status, residential location, occupation, etc.

In an embodiment, the one or more viewer demographics may be associated with the determined 110 advertisement consumption analytic. The association of viewer demographics and advertisement consumption analytics may, for example, allow for the delivery of advertisement that may, for example, be of greater interest and/or more relevant to a particular view. Various additional/alternative utilizations will be readily apparent to one having skill in the art.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method comprising:
generating, via a computing device, an advertisement complex including a plurality of associated media streams; and
delivering, via the computing device, the advertisement complex over a computing network to a network connected video consumption device.

2. The method according to claim 1, wherein the advertisement complex includes a user selectable graphical representation associated with each of the plurality of associated media streams.

3. The method according to claim 1, wherein delivering the advertisement complex includes delivering a first media stream of the plurality of associated media streams as an active media stream.

4. The method according to claim 3, further including delivering a second media stream of the plurality of associated media streams as the active media stream in response to, at least in part, receiving a user selection associated with the second media stream.

5. The method according to claim 4, wherein delivering the second media stream as the active media stream includes displaying the second media stream in an active pane of the advertisement complex.

6. The method according to claim 1, wherein delivering the advertisement complex includes delivering the advertisement complex as an advertisement within a television program.

7. The method according to claim 1, further comprising determining an advertisement consumption analytic based upon, at least in part, an identity of viewed media streams, a number of viewed video streams, and a video stream play-out metric.

8. The method according to claim 7, further comprising calculating an advertisement value based upon, at least in part, the advertisement consumption analytic.

9. The method according to claim 7, further comprising determining one or more viewer demographics based upon, at least in part, a user profile associated with the video consumption device.

10. A computer program product comprising a computer readable medium having a plurality of instructions stored thereon, which, when executed by a processor, cause the processor to perform operations including:
generating an advertisement complex including a plurality of associated media streams; and
delivering the advertisement complex over a computing network to a network connected video consumption device.

11. The computer program product according to claim 10, wherein the advertisement complex includes a user selectable graphical representation associated with each of the plurality of associated media streams.

12. The computer program product according to claim 10, wherein the instructions for delivering the advertisement complex include instructions for delivering a first media stream of the plurality of associated media streams as an active media stream.

13. The computer program product according to claim 12, further including instructions for delivering a second media stream of the plurality of associated media streams as the active media stream in response to, at least in part, receiving a user selection associated with the second media stream.

14. The computer program product according to claim 13, wherein the instructions for delivering the second media stream as the active media stream include instructions for displaying the second media stream in an active pane of the advertisement complex.

15. The computer program product according to claim 10, wherein the instructions for delivering the advertisement complex include instructions for delivering the advertisement complex as an advertisement within a television program.

16. The computer program product according to claim 10, further comprising instructions for determining an advertisement consumption analytic based upon, at least in part, an identity of viewed media streams, a number of viewed video streams, and a video stream play-out metric.

17. The computer program product according to claim 16, further comprising instructions for calculating an advertisement value based upon, the advertisement consumption analytic.

18. The computer program product according to claim 16, further comprising instructions for determining one or more viewer demographics based upon, at least in part, a user profile associated with the video consumption device.

19. A system comprising:
a processor;
a memory architecture coupled with the processor;
a first software module executable by the processor and the memory architecture, the first software module configured to generate an advertisement complex including a plurality of associated media streams; and
a second software module executable by the processor and the memory architecture, the second software module configured to deliver the advertisement complex over a computing network to a network connected video consumption device.

20. The system according to claim 19, wherein the advertisement complex includes a user selectable graphical representation associated with each of the plurality of associated media streams.

21. The system according to claim 19, wherein the first software module, configured to deliver the advertisement complex, is further configured to deliver a first media stream of the plurality of associated media streams as an active media stream.

22. The system according to claim 21, further including a third software module configured to deliver a second media stream of the plurality of associated media streams as the active media stream in response to, at least in part, receiving a user selection associated with the second media stream.

23. The system according to claim 22, wherein the third software module, configured to deliver the second media stream as the active media stream, is configured to display the second media stream in an active pane of the advertisement complex.

24. The system according to claim 19, wherein the second software module, configured to deliver the advertisement complex, is configured to deliver the advertisement complex as an advertisement within a television program.

25. The system according to claim 19, further comprising a fourth software module configured to determine an advertisement consumption analytic based upon, at least in part, an identity of viewed media streams, a number of viewed video streams, and a video stream play-out metric.

26. The system according to claim 25, further comprising a fifth software module configured to calculate an advertisement value based upon, at least in part, the advertisement consumption analytic.

27. The system according to claim 25, further comprising a sixth software module configured to determine one or more viewer demographics based upon, at least in part, a user profile associated with the video consumption device.
